(19) United States
(12) Patent Application Publication
(10) Pub. No.: US 2014/0063279 A1
(43) Pub. Date: Mar. 6, 2014

(54) IMAGE CAPTURE DEVICE AND IMAGE PROCESSOR

(71) Applicant: Panasonic Corporation, Osaka (JP)

(72) Inventors: Motonori OGURA, Osaka (JP); Yukitaka TSUCHIDA, Osaka (JP); Yuji UEDA, Osaka (JP); Masahiro MURAKAMI, Kyoto (JP)

(73) Assignee: Panasonic Corporation, Osaka (JP)

(21) Appl. No.: 13/969,933

(22) Filed: Aug. 19, 2013

(30) Foreign Application Priority Data
Sep. 4, 2012 (JP) 2012-193779
Mar. 12, 2013 (JP) 2013-049314
Mar. 15, 2013 (JP) 2013-052880

(51) Int. Cl. H04N 5/232

(52) U.S. Cl. CPC H04N 5/23296
USPC 348/222.1

(57) ABSTRACT

An image capture device according to an embodiment of the present disclosure includes: an image capturing section configured to generate an image by shooting; an acceleration detector configured to detect acceleration; an angular velocity detector configured to detect angular velocity; and a controller configured to determine, when the difference between the absolute value of the acceleration that has been detected by the acceleration detector and a preset reference value is greater than a predetermined threshold value, an angle of rotation to correct the tilt of the image based on a result of detection obtained by the angular velocity detector.

### BACKGROUND

1. Technical Field

The present disclosure relates to an image capture device and an image processor.

2. Description of the Related Art

Japanese Laid-Open Patent Publication No. 2002-94877 discloses an electronic camera, which writes, on a storage medium, image data representing an image that has been cropped out of an image obtained by shooting (which will be sometimes referred to herein as a “captured image”). This electronic camera makes a correction on an image by rotating the coordinates of an image area to be cropped out of a captured image in such a direction as to cancel the tilt of the image.

The present disclosure provides an image capture device and image processor that can make a tilt correction more appropriately.

### SUMMARY

An image capture device according to the present disclosure includes: an image capturing section configured to generate an image by shooting; an acceleration detector configured to detect acceleration; an angular velocity detector configured to detect angular velocity; and a controller configured to determine, when the difference between the absolute value of the acceleration that has been detected by the acceleration detector and a preset reference value is greater than a predetermined threshold value, an angle of rotation of the image based on a result of detection obtained by the angular velocity detector.

An image processor according to the present disclosure processes a signal supplied from an image capture device that includes an image capturing section configured to generate an image by shooting, an acceleration detector configured to detect acceleration, and an angular velocity detector configured to detect angular velocity. The image processor includes: an interface configured to obtain information about the image, information about the acceleration that has been detected by the acceleration detector, and information about the angular velocity that has been detected by the angular velocity detector; and a controller configured to determine, when the difference between the absolute value of the acceleration that has been detected by the acceleration detector and a preset reference value is greater than a predetermined threshold value, an angle of rotation of the image based on a result of detection obtained by the angular velocity detector.

A device according to the present disclosure includes: a first detector configured to detect the magnitude and direction of acceleration; a second detector configured to detect any change in the device's own attitude; and a controller configured to operate either in a first mode in which the device's own attitude is determined by the direction of the acceleration indicated by a result of detection obtained by the first detector or in a second mode in which the device's own attitude is determined by tracking changes in its own attitude based on a result of detection obtained by the second detector. When the magnitude of acceleration indicated by a result of detection obtained by the first detector falls within a predetermined range that is defined with respect to the magnitude of the acceleration of gravity, the controller operates in the first mode. And When the magnitude of acceleration indicated by the result of detection obtained by the first detector falls out of the predetermined range, the controller operates in the second mode.

According to the technique of the present disclosure, an image capture device and image processor that can make a tilt correction more appropriately can be provided.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a block diagram illustrating an electrical configuration for a digital camcorder 100.

FIG. 2A schematically illustrates the axes of detection of an acceleration sensor and an angular velocity sensor, and FIGS. 2B and 2C illustrate examples of X- and Y-components of the gravitational acceleration.

FIG. 3 shows how the magnitude of tilt may be detected erroneously by the acceleration sensor.

FIG. 4 is a flowchart showing the procedure of processing of determining whether the output of the acceleration sensor, on which the tilt correction should to be made if a predetermined condition is satisfied, is an appropriate one or not.

FIG. 5 schematically shows the relation among the magnitude of tilt calculated based on the output of the angular velocity sensor, the magnitude of tilt calculated based on the output of the acceleration sensor, and the difference between the three-axis sum and the acceleration of gravity.

FIG. 6 illustrates schematically how tilt correction processing gets done on an image.

FIG. 7 is a block diagram showing a configuration for a system according to another embodiment.

FIG. 8 is flowchart showing how the system operates in the embodiment shown in FIG. 7.

FIG. 9 is a block diagram illustrating a configuration for a device according to still another embodiment.

### DETAILED DESCRIPTION

Hereinafter, embodiments will be described in detail with reference to the accompanying drawings as needed. It should be noted that the description thereof will be sometimes omitted unless it is absolutely necessary to go into details. For example, description of a matter that is already well known in the related art will be sometimes omitted, so will be a redundant description of substantially the same configuration. This is done solely for the purpose of avoiding redundancies and making the following description of embodiments as easily understandable for those skilled in the art as possible.

It should be noted that the present inventors provide the accompanying drawings and the following description to help those skilled in the art understand the present disclosure fully. And it is not intended that the subject matter defined by the appended claims is limited by those drawings or the description.

### Embodiment 1

Hereinafter, a first embodiment in which the technique of the present disclosure is applied to a digital camcorder will be described with reference to the accompanying drawings. In the following description, a signal or data representing an image will be sometimes simply referred to herein as an “image”. Also, the lateral direction of the digital camcorder will be sometimes referred to herein as “horizontal direction” and its longitudinal direction as “perpendicular (or vertical) direction”, respectively.

### 1-1. Outline

The digital camcorder 100 of this embodiment has a tilt correction function and a rotational shake correction function. In this description, the “tilt correction function” is a function for correcting the tilt of a captured image which is caused by the device's own tilt with respect to the horizontal plane during shooting. The digital camcorder 100 has the function of correcting electronically the tilt of an image by calculating, based on the output of an acceleration sensor (acceleration detector) 260 that detects the acceleration, how much the perpendicular direction of its own device tilts with respect to the direction of the acceleration of gravity and rotating the coordinates of the image in a direction in which the tilt of the image can be canceled. On the other hand, the rotational shake correction function refers herein to the function of reducing the influence of the device's own shake (i.e., so-called “camera shake”) during shooting on the captured image. The digital camcorder 100 has the function of correcting electronically the rotational shake of the image by rotating, based on the output of an angular velocity sensor (angular velocity detector) 250, the coordinates of an image to be cropped out of the captured image in a direction in which the shake in the roll direction (i.e., the direction of rotation that is defined with respect to the forward/backward direction of the camera as its axial direction) is canceled.

Hereinafter, a specific configuration and operation of the digital camcorder 100 will be described.

### 1-2. Configuration

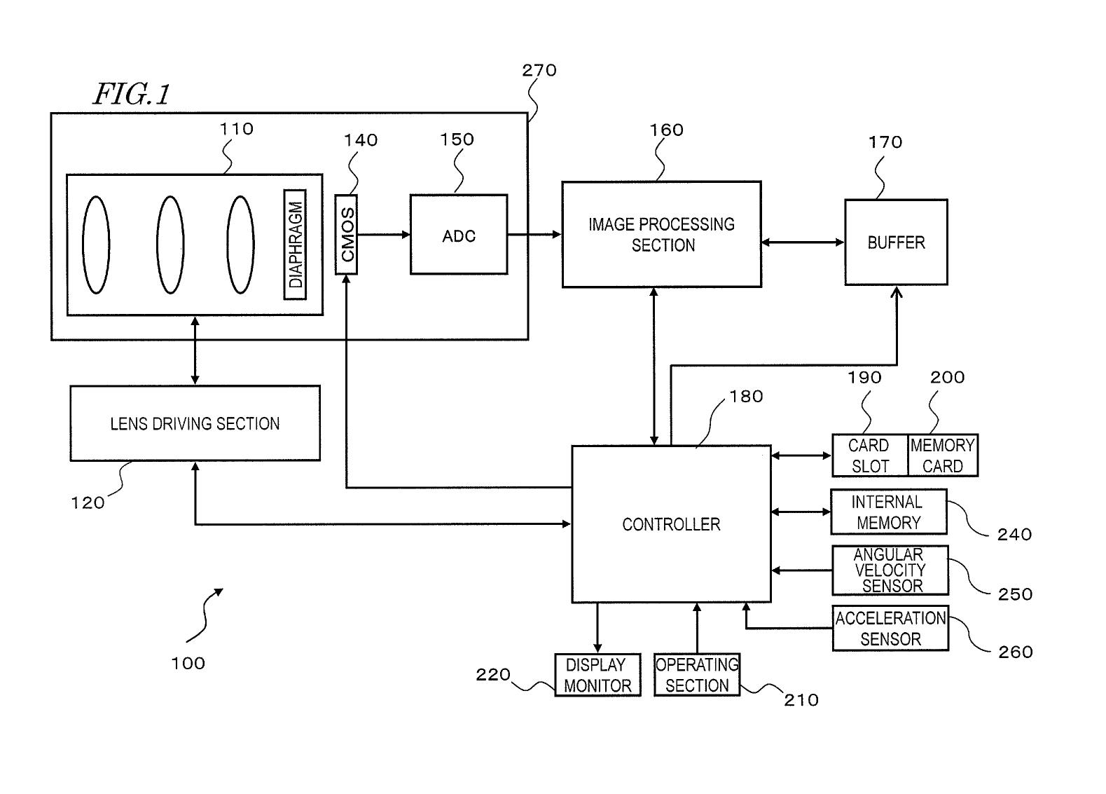

Hereinafter, a configuration for the digital camcorder 100 of this embodiment will be described. FIG. 1 is a block diagram illustrating a configuration for the digital camcorder 100 and illustrates how respective components of this digital camcorder 100 are electrically connected together. This digital camcorder 100 includes an image capturing section 270, an image processing section 160, a buffer 170, a controller 180, a card slot 190, a memory card 200, an operating section 210, a display monitor 220, an internal memory 240, an angular velocity sensor 250, and an acceleration sensor 260. The image capturing section 270 includes an optical system 110, a lens driving section 120, a CMOS image sensor 140 and an A/D converter (ADC) 150.

The digital camcorder 100 obtains a subject image that has been produced through the optical system 200 including a single or multiple lenses converted into an electrical signal by the CMOS image sensor 140. The electrical signal generated by the CMOS image sensor 140 is subjected to various kinds of processing at the image processing section 160 and then stored on the memory card 200. Hereinafter, these components of this digital camcorder 100 will be described in further detail.

The optical system 110 includes a zoom lens, an optical image stabilizer (OIS) lens, a focus lens, a diaphragm, and other optical elements. By moving the zoom lens along the optical axis, the subject image produced on the image capturing plane of the CMOS image sensor 140 can be either zoomed in on or zoomed out. Also, by moving the focus lens along the optical axis, the focus of the subject image can be adjusted. The OIS lens is configured to be movable within a plane that crosses the optical axis of the optical system 110 at right angles. By shifting the OIS lens in such a direction as to cancel the shake of the digital camcorder 100, the influence of the shake of the digital camcorder 100 on the captured image can be reduced. The diaphragm adjusts the size of the aperture either in accordance with the user's setting or automatically, thereby controlling the quantity of light transmitted. In FIG. 1, three lenses are illustrated. However, this is only an example and any other appropriate number of lenses may be used according to the functions and performance required.

Optionally, the optical system 110 may further include a zoom actuator which drives the zoom lens, an OIS actuator which drives the OIS lens, a focus actuator which drives the focus lens, and a diaphragm actuator which drives the diaphragm.

The lens driving section 120 drives these various kinds of lenses and diaphragm included in the optical system 110. For example, the lens driving section 120 controls the zoom actuator, focus actuator, OIS actuator and diaphragm actuator which may be included in the optical system 110.

The CMOS image sensor 140 converts the subject image that has been produced by the optical system 110 into an electrical signal, thereby generating analog image data. The CMOS image sensor 140 performs various kinds of operations including exposure, transfer and electronic shuttering. Optionally, the CMOS image sensor 140 may be replaced with any other kind of image sensor such as a CCD image sensor or an NMOS image sensor.

The A/D converter 150 is a circuit which converts the analog image data that has been generated by the CMOS image sensor 140 into digital image data. The output of the A/D converter 150 is passed to the image processing section 160.

The image capturing section 270 is made up of a plurality of components including the optical system 110, the CMOS image sensor 140 and the A/D converter 150. The image capturing section 270 sequentially generates digital image data, including a plurality of frames that are continuous with each other on the time axis, by capturing an image and outputs the digital image data one after another.

The image processing section 160 is a circuit which performs various kinds of processing on the image data that has been generated by the CMOS image sensor 140. The image processing section 160 may be implemented as a digital signal processor (DSP) or a microcontroller (microprocessor), for example. The image processing section 160 generates image data to be displayed on the display monitor 220 or image data to be stored on the memory card 200. For example, the image processing section 160 performs gamma correction, white balance correction, flaw correction and various other kinds of processing on the image data that has been generated by the CMOS image sensor 140. Also, the image processing section 160 compresses the image data that has been supplied from the image capturing section 270 compliant with a predetermined standard such as the H.264 standard or the MPEG-2 standard.

The image processing section 160 subjects the image data to coordinate rotation processing, thereby reducing the tilt in the roll direction to be caused to the image produced on the image capturing plane of the CMOS image sensor 140 by the device's own tilt or rotational shake during shooting. Suppose a situation where the digital camcorder 100 has rotated θ degrees counterclockwise due to the hand tremor of a person who is shooting a subject image or a situation where the shooter has shot the subject image with the digital camcorder 100 tilted 0 degrees counterclockwise with respect to its reference position from the beginning (i.e., intentionally). In each of these cases, a corrected image is generated by rotating the entire image θ degrees clockwise thanks to the tilt and rotational shake correction function of the image processing section 160. At this time, the image processing section 160 rotates the coordinates of the image data θ degrees clockwise and then crops image data out of an appropriate range. As a result, image data in which the subject is not tilted in the direction of rotation can be cropped. In this manner, the image processing section 160 generates an image that has had its shake in the direction of rotation reduced.

The controller 180 is a processor which controls the overall operation of this digital camcorder. The controller 180 may be implemented as a semiconductor integrated circuit such as a microprocessor, for example. In one embodiment, the controller 180 may be implemented as combination of a central processing unit (CPU) and a program (software). Alternatively, the controller 180 may also be implemented as only a set of dedicated hardware components. The controller 180 may generate a vertical sync signal at 60 fps, for example. The magnitude of tilt correction to be made based on the respective outputs of the angular velocity sensor 250 and the acceleration sensor 260 is calculated within one period of the vertical sync signal. In this manner, an image that has had its tilt corrected appropriately can be obtained. It should be noted that one period of the vertical sync signal does not have to be 60 fps but may also be set to be any other value.

In FIG. 1, the image processing section 160 and the controller 180 are illustrated as two separate components. However, the image processing section 160 and the controller 180 may also be implemented as a single physically combined integrated circuit. That is to say, the image processing section 160 and the controller 180 do not have to be implemented on two different semiconductor chips but may also form a single semiconductor chip as well.

The buffer 170 functions as a work memory for the image processing section 160 and the controller 180 and may be implemented as a DRAM or a ferroelectric memory, for example.

The card slot 190 is an interface, to/from which the memory card 200 is readily insertable and removable, and can be connected to the memory card 200 both mechanically and electrically. The memory card 200 includes a flash memory, a ferroelectric memory or any other kind of internal memory, and can store image files and other data that have been generated by the image processing section 160. It should be noted that the memory card 200 shown in FIG. 1 does not form part of the digital camcorder 100 but is an external component.

The internal memory 240 may be implemented as a flash memory or a ferroelectric memory, for example, and may store a control program for controlling the overall operation of this digital camcorder 100.

The operating section 210 is a generic term which collectively refers to various kinds of user interfaces through which the user can enter his or her instructions. The operating section 210 includes cross keys and an ENTER button which accept the user's instructions.

The display monitor 220 may be implemented as a liquid crystal display or an organic EL display, for example. The display monitor 220 may display either an image represented by the image data that has been supplied from the image capturing section 270 and processed by the image processing section 160 (i.e., a through-the-lens image) or an image represented by the image data that has been read out from the memory card 200. In addition, the display monitor 220 can also display various kinds of menus which allow the user to change various settings of this digital camcorder 100.

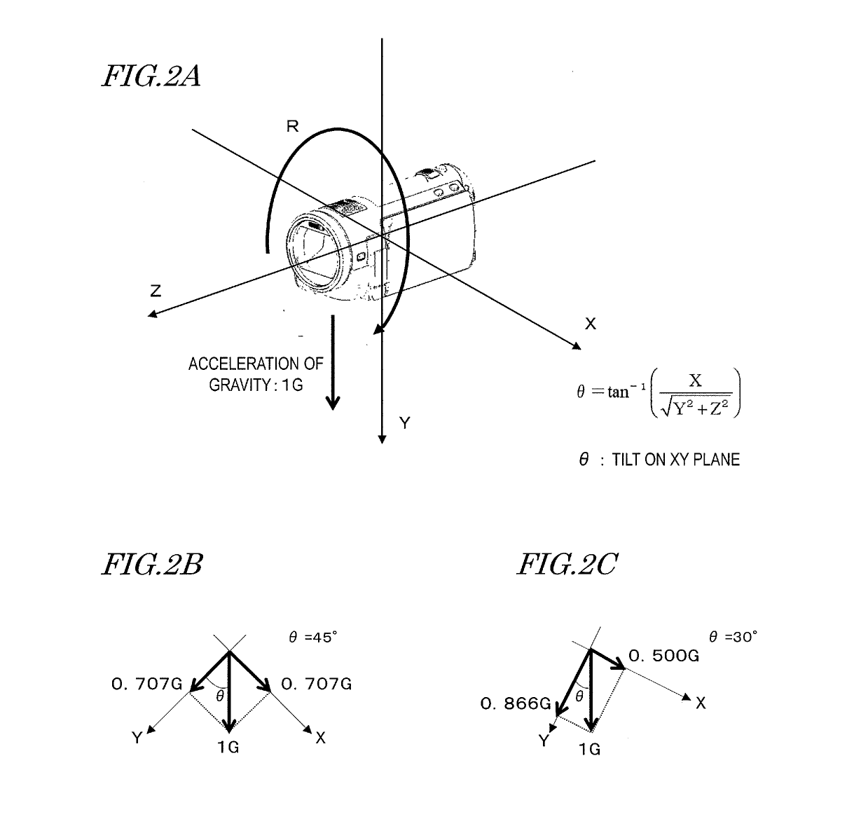

As described above, the digital camcorder 100 of this embodiment includes an acceleration sensor 260 and an angular velocity sensor 250. Hereinafter, the respective axes of detection of the acceleration sensor 260 and the angular velocity sensor 250 will be described with reference to FIG. 2A, which schematically illustrates the axes of detection of the acceleration sensor 260 and the angular velocity sensor 250.

The acceleration sensor 260 is a sensor which detects the tilt of this digital camcorder 100 in the perpendicular direction with respect to the direction of the acceleration of gravity. As the acceleration sensor 260, a semiconductor acceleration sensor such as a capacitance coupled type, a piezoresistance type or a heat sensing type may be used, for example. However, the acceleration sensor 260 does not have to be such a semiconductor sensor, but may also be an optical or mechanical sensor as well.

As shown in FIG. 2A, the acceleration sensor 260 of this embodiment includes a sensor which detects an acceleration component in the optical axis direction (i.e., the Z-axis direction) of this digital camcorder 100, a sensor which detects an acceleration component within a plane that crosses the Z-axis at right angles and in the horizontal direction (i.e., X-axis direction) of this digital camcorder 100, and a sensor which detects an acceleration component within a plane that crosses the Z-axis at right angles and in the perpendicular direction (i.e., Y-axis direction) of this digital camcorder 100. In this description, these sensors will be collectively referred to herein as an “acceleration sensor 260”. Since the X-, Y- and Z-axes are fixed with respect to this digital camcorder 100, the acceleration components detected in these X-, Y- and Z-axis directions vary as this digital camcorder 100 changes its attitude.

Information about the acceleration which has been detected by the acceleration sensor 260 in the X-, Y- and Z-axis directions is provided for the controller 180. By analyzing the respective output signals in the X-, Y- and Z-axis directions of the acceleration sensor 260, the controller 180 can calculate a first quantity of correction (i.e., a first angle of correction) to correct the tilt of the digital camcorder 100. In this case, if the respective values of the acceleration components that have been detected in the X-, Y- and Z-axis directions are indicated by X, Y and Z, respectively, the tilt angle θ defined by the Y-axis with respect to the direction of the acceleration of gravity of this digital camcorder 100 can be calculated by the following Equation (1):

$$θ = {tan}^{- 1} ( \frac{X}{\sqrt{{Y}^{2} + {Z}^{2}}} ) . \qquad ( 1 )$$

For example, suppose that if the magnitude of the acceleration of gravity is 1 G (approximately 9.807 m/s²), the acceleration values of the respective components that have been detected by the acceleration sensor 260 have turned out to be X=Y=0.707 G and Z=0 as shown in FIG. 2B, which represents a situation where this digital camcorder 100 is not tilted but in the roll (R) direction. In that case, the controller 180 obtains θ=45 degrees as a result of calculation that has been made based on Equation (1). On the other hand, suppose that the acceleration values of the respective components that have been detected by the acceleration sensor 260 have turned out to be X=0.500 G, Y=0.866 G and Z=0 as shown in FIG. 2C. In that case, the controller 180 obtains θ=30 degrees as a result of calculation that has been made based on Equation (1). In any case other than these, the controller 180 can also calculate the tilt angle θ by Equation (1).

The angular velocity sensor 250 detects the angular velocity of this digital camcorder 100. The angular velocity sensor 250 may be a vibrating gyrosensor, for example, which can sense the angular velocity by measuring the magnitude of displacement of a rotating vibrator being subjected to the Coriolis force. Optionally, an optical sensor or any other kind of sensor may also be used as the angular velocity sensor 250.

As shown in FIG. 2A, the angular velocity sensor 250 of this embodiment includes a sensor which detects the angular velocity of the movement of this digital camcorder 100 to be caused in the roll (R) direction due to a camera shake, for example. The angular velocity sensor 250 may further include a sensor for detecting the angular velocity in the yaw direction (i.e., the direction of rotation around the Y-axis) and a sensor for detecting the angular velocity in the pitch direction (i.e., the direction of rotation around the X-axis), in addition to the sensor for detecting the angular velocity in the roll direction. By analyzing the output signal of the angular velocity sensor 250 as for the roll direction, the controller 180 can calculate a second quantity of correction (i.e., a second angle of correction) to make a correction on the shake of this digital camcorder 100 in the roll direction during a shooting session.

It should be noted that the set of components shown in FIG. 1 is just an example and some of these components may be omitted from this digital camcorder 100 as long as the digital camcorder 100 can perform the operation to be described later. Also, this digital camcorder 100 may further include a power supply, a storage device such as a hard disk drive, a flash, an external interface and any other additional components.

### 1-3. Operation

By performing coordinate rotation processing on the image data, the digital camcorder 100 of this embodiment can reduce the influence of its own tilt in the roll direction on the image that has been produced on the image capturing plane of the CMOS image sensor 140.

In this case, the digital camcorder 100 determines, based on the result provided by the acceleration sensor 260, whether the image shot needs to have its tilt corrected based on the first quantity of correction that has been calculated based on the output of the acceleration sensor 260 or the second quantity of correction that has been calculated based on the output of the angular velocity sensor 250.

Hereinafter, it will be described in detail exactly how the digital camcorder 100 performs the tilt correcting operation.

### 1-3-1. Erroneous Detection of Tilt Angle

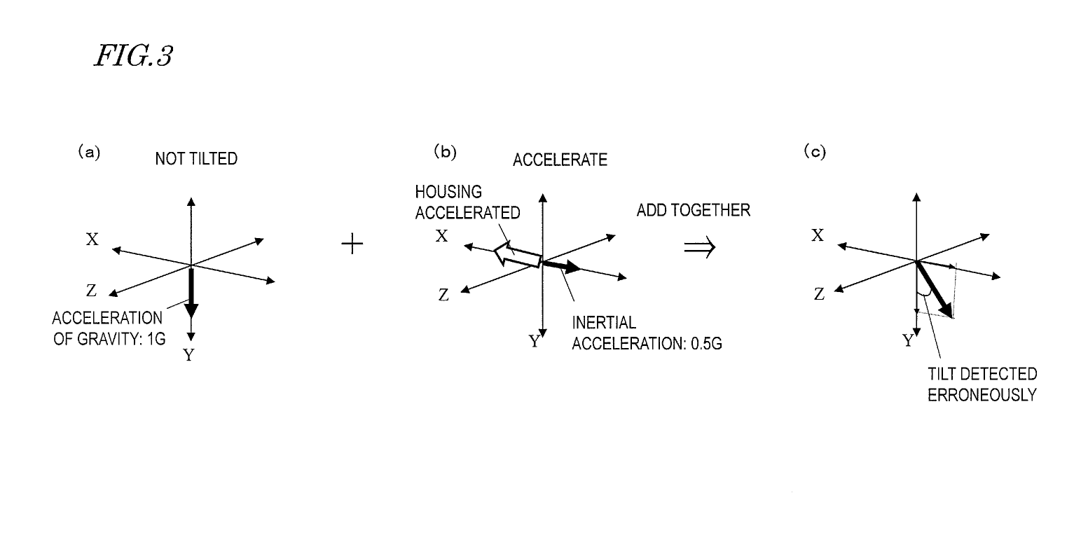

First of all, it will be described with reference to FIG. 3 how the magnitude of tilt (i.e., tilt angle) may be detected erroneously by the acceleration sensor 260 if the digital camcorder 100 is making an accelerated motion during a shooting session. FIG. 3 illustrates how the acceleration sensor 260 may detect the magnitude of tilt erroneously.

As described above, the acceleration sensor 260 calculates the magnitude of tilt based on the respective output values of the acceleration components in the X-, Y- and Z-axis directions, which represent the respective axes of detection of the three sensors. More specifically, the controller 180 calculates the magnitude of tilt by Equation (1) based on the ratio of distribution of the acceleration of gravity 1 G among the respective components in the X-, Y- and Z-axis directions.

While the camcorder itself is making no accelerated motion, no inertial force other than the gravity is applied to the acceleration sensor 260. In this description, such a state will be referred to herein as a state in which “no acceleration other than the acceleration of gravity has been produced”. If no acceleration other than the acceleration of gravity has been produced in the camcorder itself, the absolute value of the sum of the vectors representing the acceleration of the acceleration sensor 260 in the X-, Y- and Z-axis directions (which will be sometimes referred to herein as a “three-axis sum”) agrees with the acceleration of gravity G. In that case, since no acceleration other than the acceleration of gravity is produced in the camcorder itself, the controller 180 can calculate the camcorder's own tilt angle accurately by making the arithmetic operation given by Equation (1).

On the other hand, while the camcorder itself is making an accelerated motion, some inertial force other than the gravity is applied to the acceleration sensor 260. In this description, such a state will be referred to herein as a state in which “acceleration other than the acceleration of gravity has been produced”. If acceleration other than the acceleration of gravity has been produced in the camcorder itself, the controller 180 cannot calculate the camcorder's own tilt angle accurately by making the arithmetic operation given by Equation (1). This point will be described with reference to FIG. 3.

FIG. 3 illustrates, as an example, how the tilt may be detected erroneously as shown in FIG. 3(c) due to the resultant acceleration to be obtained when the housing of the digital camcorder 100 is accelerated dynamically at an acceleration of 0.5 G in the positive X-axis direction as shown in FIG. 3(b) in the state where the acceleration detected by the acceleration sensor 260 has only a Y component and its magnitude is 10 (i.e., in the state where there is no tilt) as shown in FIG. 3(a). In that case, the acceleration of gravity 1 G is produced in the positive Y-axis direction and an inertial acceleration of 0.5 G is produced due to the dynamic motion in the negative X-axis direction. As described above, in calculating the magnitude of tilt, the controller 180 uses the ratio of the acceleration components in the respective axis directions. That is why the controller 180 takes the acceleration in the negative X-axis direction involved with the dynamic motion (i.e., accelerated motion) for what has been caused by the camcorder's own tilt by mistake as shown in FIG. 3(c). In this manner, if inertial acceleration has been produced due to dynamic motion, it is difficult for the acceleration sensor 260 to calculate the magnitude of tilt accurately based on the acceleration of gravity. That is to say, if inertial acceleration has been produced due to dynamic motion other than the acceleration of gravity, the result of detection obtained by the acceleration sensor 260 is not necessarily a reliable one.

The present inventors faced such a problem that even when acceleration was produced due to the dynamic motion of the camcorder itself, such erroneous detection should be minimized and appropriate tilt correction should be made. Hereinafter, it will be described how to perform a tilt correction operation in order to overcome this problem.

<1-3-2. How to Change the Modes of Processing from Determining Whether there is any Dynamic Acceleration into Calculating Magnitude of Tilt or Vice Versa>

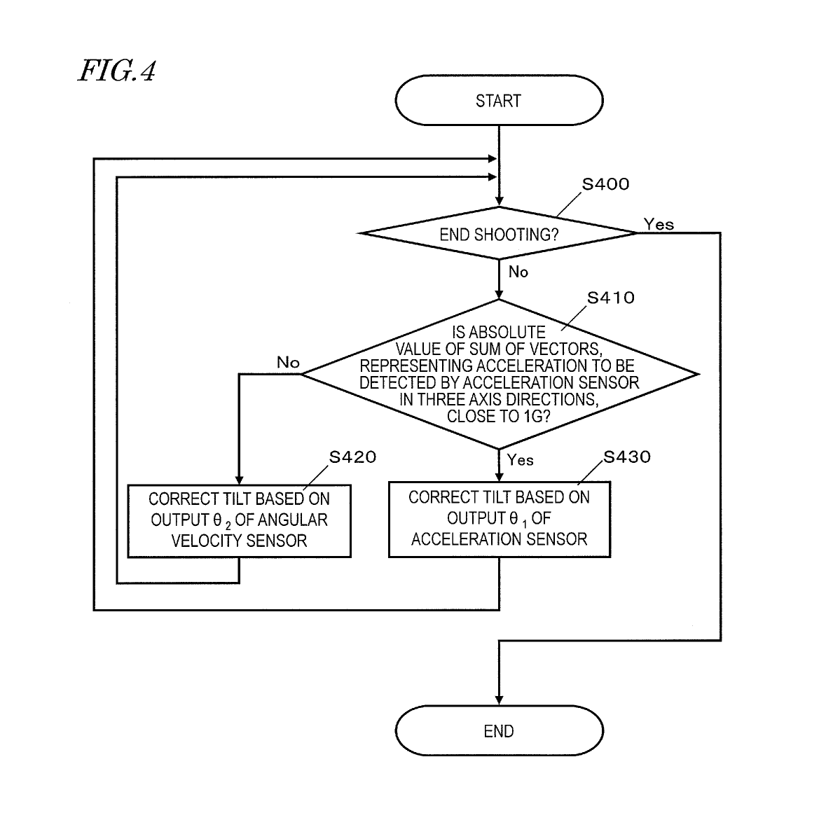

FIG. 4 is a flowchart showing the procedure of processing of determining the magnitude of tilt according to this embodiment. On accepting the user's instruction to start shooting, the digital camcorder 100 enters a shooting mode and continues to perform a shooting session until the camcorder 100 is instructed to stop shooting. In this case, in response to a vertical sync signal, the respective components of the digital camcorder 100 sequentially generate image frames at a frame rate of 60 fps, for example. When those frames are generated, tilt correction processing is carried out in the following manner.

In the shooting mode, the controller 180 determines whether or not an instruction to end the shooting session has been received (in Step S400). If the answer is NO, the controller 180 determines whether or not the digital camcorder 100 is in a dynamically accelerated state (in Step S410). In this embodiment, the controller 180 calculates the absolute value of the sum of the vectors representing the acceleration of the acceleration sensor 260 in the X-, Y- and Z-axis directions (i.e., the three-axis sum), thereby determining whether or not the camcorder itself is in the dynamically accelerated state. If no acceleration other than the acceleration of gravity has been produced in the camcorder itself, the absolute value of the sum of the vectors representing the acceleration of the acceleration sensor 260 in the X-, Y- and Z-axis directions substantially agrees with the acceleration of gravity 1 G. On the other hand, if any dynamic acceleration, i.e., any acceleration other than the acceleration of gravity, has been produced in the camcorder itself, then the three-axis sum detected by the acceleration sensor 260 is no longer close to the acceleration of gravity 1 G. For example, if the digital camcorder 100 is making an accelerated motion perpendicularly upward, then not only the gravity but also perpendicularly downward inertial force are produced. As a result, the three-axis sum detected by the acceleration sensor 260 becomes greater than 1 G. Conversely, if the digital camcorder 100 is making an accelerated motion perpendicularly downward, then not only the perpendicularly downward gravity but also perpendicularly upward inertial force are produced. As a result, the three-axis sum detected by the acceleration sensor 260 becomes smaller than 1 G. Based on this principle, the controller 180 examines whether the three-axis sum is close to 1 G or not, thereby determining whether or not any acceleration other than the acceleration of gravity has been produced. In this case, if the three-axis sum is “close to” 1 G, the decision is made that no acceleration other than the acceleration of gravity has been produced in order to take the influence of errors involved with the accuracy of detection of the acceleration sensor 260 into consideration.

In this manner, if the three-axis sum falls out of a range that has been defined in advance with respect to 1 G (e.g., the range of 1 G−0.01 G to 1 G+0.01 G), then the controller 180 determines that this is a dynamically accelerated state. On the other hand, if the three-axis sum falls within the range that has been defined in advance with respect to 1 G (e.g., the range of 1 G−0.01 G to 1 G+0.01 G), then the controller 180 determines that this is not a dynamically accelerated state (i.e., this is a static state in which only gravity is applied). As can be seen, if the absolute value of the difference between the absolute value of the acceleration that has been detected by the acceleration sensor 260 and a predetermined reference value is greater than a preset threshold value, the controller 180 determines that this is a dynamically accelerated state. Otherwise, the controller 180 determines that this is a statically accelerated state.

In this embodiment, the reference value is supposed to be identical with the acceleration of gravity (of approximately 9.807 m/s²) on the surface of the earth. The reason is that the shooting session is supposed to be performed on the ground surface unless otherwise stated. That is why if a shooting session needs to be performed in a special environment in which the acceleration of gravity is different from the value on the ground surface, e.g., at a height, deep under the sea, or in space, then the reference value is set to be a different value according to that environment. That is why the digital camcorder 100 may be configured to allow the user to change the settings of this reference value. For example, the user may be allowed to set an appropriate reference value according to the shooting environment by operating the operating section 210. Also, the threshold value does not have to be 0.01 G but may also be set to be smaller than, or larger than, 0.01 G as well. And this threshold value is set appropriately according to the performance required. The operating section 210 and the controller 180 may be configured to allow the user to set that range arbitrarily, too.

If the decision has been made that this is a dynamically accelerated state (i.e., if the answer to the query of the processing step S410 is NO), then the controller 180 calculates the magnitude of tilt of the camcorder itself based on the output signal of the angular velocity sensor 250 (in Step S420). Specifically, the controller 180 finds the integral of the outputs of the angular velocity sensor 250 (i.e., angular velocity values) that have been sequentially accumulated in the buffer 170 as frames have been generated one after another, thereby calculating the magnitude of tilt of the camcorder itself. In this case, the current tilt may be calculated with respect to the output (i.e., tilt) of the acceleration sensor 260 at a point in time when the camcorder was in a static state by accumulating the angular velocity values from that point in time on. Based on the current tilt that has been obtained in this manner, the controller 180 calculates the quantity of correction of the camcorder's own tilt (which will be referred to herein as the “angle of correction θ2”). Then, the controller 180 notifies the image processing section 160 of the angle of correction θ2 thus calculated. In response, the image processing section 160 makes a tilt correction on the captured image using the angle of correction θ2 that has been calculated by the controller 180 based on the output signal of the angular velocity sensor 250. The angular velocity sensor 250 outputs a signal representing the camcorder's own angular velocity, not the camcorder's own acceleration, and therefore, can calculate the angle even in such a dynamically accelerated state. As a result, in the dynamically accelerated state, the magnitude of tilt can be calculated with more reliability based on the output signal of the angular velocity sensor 250, instead of the output of the acceleration sensor 250 that might involve erroneous detection. Consequently, the image processing section 160 can make a more reliable tilt correction on the captured image.

On the other hand, if the decision has been made that this is not a dynamically accelerated state and that no acceleration other than the acceleration of gravity has been produced (i.e., if the answer to the query of the processing step S410 is YES), then the output value of the acceleration sensor 260 is a reliable one. Thus, the controller 180 calculates the magnitude of the camcorder's own tilt based on the output signal of the acceleration sensor 260 (in Step S430). Based on the magnitude of tilt thus calculated, the controller 180 calculates the quantity of correction (i.e., the angle of correction θ1) on the magnitude of the camcorder's own tilt. And the controller 180 notifies the image processing section 160 of the angle of correction θ1 thus calculated. In this manner, the image processing section 160 makes a tilt correction on the captured image using the angle of correction θ1 that has been calculated based on the output signal of the acceleration sensor 260. It should be noted that if no acceleration other than the acceleration of gravity has been produced, then it means that the camcorder is either standing still or making a uniform linear motion. That is why in such a state, the magnitude of tilt cannot be calculated based on the output value of the angular velocity sensor 250. On the other hand, if there is no dynamic acceleration and only the acceleration of gravity has been detected, then the magnitude of tilt can be calculated accurately based on the output signal of the acceleration sensor 260. Consequently, the image processing section 160 can make a tilt correction on the captured image more perfectly.

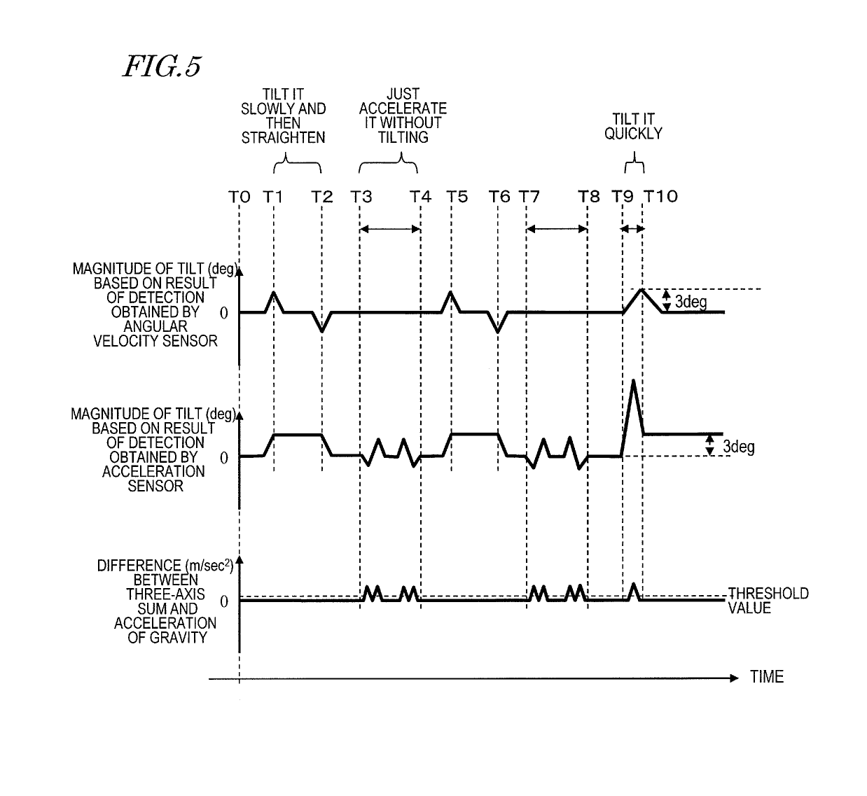

Next, the processing steps S410 through S430 in the flowchart shown in FIG. 4 will be described in further detail with reference to the exemplary output waveforms shown in FIG. 5, which schematically shows the relation among the magnitude of tilt that has been calculated based on the result of detection obtained by the angular velocity sensor 250, the magnitude of tilt that has been calculated based on the result of detection obtained by the acceleration sensor 260, and the difference between the three-axis sum and the acceleration of gravity 1G. In FIG. 5, shown along the time axis are a waveform representing the magnitude of tilt (in degrees) in the R direction that has been calculated based on the output of the angular velocity sensor 250, a waveform representing the magnitude of tilt (in degrees) in the R direction that has been calculated based on the output of the acceleration sensor 260 (in X-, Y- and Z-axis directions) and a waveform representing the difference between the absolute value of the three-axis sum of acceleration of the acceleration sensor 260 and the acceleration of gravity 1 G.

The output waveform in the interval from T1 through T2 (and the interval from T5 through T6) shown in FIG. 5 indicates a situation where the housing of the digital camcorder 100 gets tilted slowly, left standing still for a while, and then straightened back to its original horizontal position. When the housing gets tilted and when it is straightened back to its original horizontal position, an angular velocity is generated in the R direction. That is why the controller 180 calculates the magnitude of tilt (e.g., ±3 degrees in the example shown in FIG. 5) based on the output of the angular velocity sensor 250 that detects an angular velocity in the R direction at the times T1 and T2 (and at the times T5 and T6). In the interval from T1 through T2 (and in the interval from T5 through T6), the housing is kept tilted and left standing still, and therefore, no angular velocity is generated and the controller 180 does not calculate any magnitude of tilt based on the output of the angular velocity sensor 250. In the meantime, in this interval, the acceleration of gravity that has been broken down into respective components in the X-, Y- and Z-axis directions is detected by the acceleration sensor 260. And the controller 180 calculates the magnitude of the camcorder's own tilt based on the distribution of the acceleration components in the X-, Y- and Z-axis directions that have been supplied from the acceleration sensor 260. In this case, since the absolute value of the three-axis resultant acceleration that has been detected by the acceleration sensor 260 is equal to or smaller than a predetermined threshold value (i.e., a threshold value that has been defined with the sensor's sensing error taken into account) with respect to the acceleration of gravity 1 G, the controller 180 determines that the camcorder itself is currently standing still and calculates the magnitude of tilt based on the output of the acceleration sensor 160.

The output waveform in the interval from T3 through T4 (and the interval from T7 through T8) shown in FIG. 5 indicates a situation where only an acceleration operation is performed without tilting the digital camcorder 100 at all. In the interval from T3 through T4 (and in the interval from T7 through T8), the operation of tilting the housing is not performed, and therefore, the angular velocity detected by the angular velocity sensor 250 in the R direction is substantially equal to zero. In the meantime, the acceleration sensor 260 detects not only the acceleration of gravity but also the inertial acceleration involved with the acceleration operation in the X-, Y- and Z-axis directions. In this case, since the absolute value of the three-axis resultant acceleration that has been detected by the acceleration sensor 260 exceeds the predetermined threshold value with respect to the acceleration of gravity 1 G, the controller 180 determines that force other than the gravity, (i.e., inertial force) is being applied to the digital camcorder 100 (i.e., the camcorder 100 is in a dynamically accelerated state). In such a situation, it is difficult to calculate the magnitude of the camcorder's own tilt accurately based on the output signal of the acceleration sensor 260. That is why the controller 180 calculates the magnitude of the camcorder's own tilt based on the output signal of the angular velocity sensor 250. By calculating the magnitude of tilt based on the output signal of the angular velocity sensor 250, the controller 180 can sense correctly that the digital camcorder 100 is not tilted in this interval from T3 through T4 (and in the interval from T7 through T8).

The output waveform in the interval from T9 through T10 shown in FIG. 5 indicates a situation where the operation of tilting the digital camcorder 100 quickly has been performed. As a result of this tilting operation, an angular velocity is generated in the R direction in this digital camcorder 100. While this operation of tilting the camcorder 100 quickly is being performed, the absolute value of the three-axis resultant acceleration that has been detected by the acceleration sensor 260 exceeds the predetermined threshold value with respect to the acceleration of gravity 1 G. In such a situation, it is difficult to calculate the magnitude of the camcorder's own tilt accurately based on the output signal of the acceleration sensor 260. That is why the controller 180 calculates the magnitude of the camcorder's own tilt based on the output signal of the angular velocity sensor 250. By calculating the magnitude of tilt based on the output signal of the angular velocity sensor 250, the camcorder's own tilt can also be detected correctly even in this interval from T9 through T10. In the example shown in FIG. 5, after the operation of tilting the camcorder 100 quickly has gotten done, the camcorder 100 enters a static state, and therefore, the controller 180 will calculate the magnitude of tilt from then on based on the output of the acceleration sensor 260.

As can be seen, the digital camcorder 100 of this embodiment determines whether the camcorder itself is in a dynamically accelerated state or in a static state during a shooting session. By changing the modes of the magnitude of tilt calculating processing depending on the decision result, the tilt correction can be made appropriately.

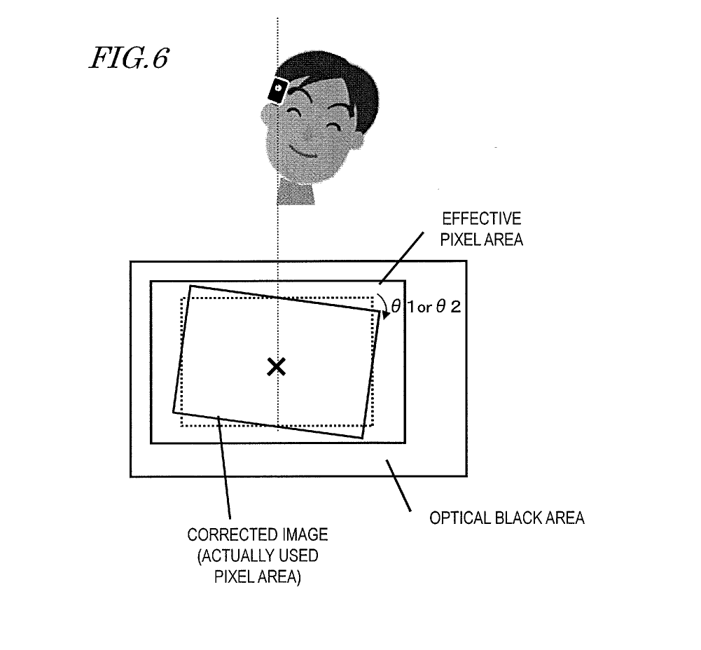

The image processing section 160 rotates the given image by the angle of correction θ1 or θ2 that has been provided by the controller 180 in such a direction as to reduce the tilt of the image. As a result, a tilt-corrected image can be obtained just as intended. Hereinafter, it will be described with reference to FIG. 6 how the tilt correction processing gets done by the image processing section 160.

FIG. 6 schematically illustrates how to perform the tilt correction processing. In FIG. 6, illustrated is an example in which the digital camcorder 100 is used as a wearable camera that the user uses by wearing it on his or her face or clothes. In FIG. 6, illustrated are image areas corresponding to the optical black area, effective pixel area and actually used pixel area in the CMOS image sensor 140. The image processing section 160 rotates the image supplied from the image capturing section 270 by the angle of correction θ1 or θ2 in such a direction as to reduce the tilt of the image, and then performs image cropping processing in the effective pixel area of the CMOS image sensor 140. Then, the image processing section 160 outputs the cropped image (i.e., the image in the actually used pixel area indicated by the solid rectangle) as a corrected image. As a result, even if the tilt of the captured image in the roll direction is corrected, an image that does not include any pixel in the optical black area can also be recorded just as intended.

### 1-4. Effects

As described above, a digital camcorder (which is an exemplary image capture device) 100 according to this embodiment includes: an image capturing section 270 which generates an image by shooting; an acceleration sensor (which is an exemplary acceleration detector) 260 which detects acceleration; an angular velocity sensor (which is an exemplary angular velocity detector) 250 which detects an angular velocity; and a controller 180 which determines, if the difference between the absolute value of the acceleration that has been detected by the acceleration sensor 260 and preset reference value is greater than a predetermined threshold value, an angle of rotation to correct the tilt of the image based on a result of detection obtained by the angular velocity sensor 250. By adopting such configuration, even if the digital camcorder 100 is in accelerated motion during a shooting session, the tilt of the image can be corrected appropriately by setting the reference value and the threshold value to be proper values.

On the other hand, if the difference between the absolute value of the acceleration that has been detected by the acceleration sensor 260 and the preset reference value is equal to or smaller than the threshold value, then the controller 180 determines the angle of rotation to correct the tilt of the image (i.e., the angle of correction) based on a result of detection obtained by the acceleration sensor 260. That is to say, the angle of correction is determined based on the output of the acceleration sensor 260 if the difference is equal to or smaller than the threshold value but is determined based on the output of the angular velocity sensor 250 if the difference is greater than the threshold value. As a result, if the tilt can be detected properly based on the output of the acceleration sensor 260, the angle of correction can be determined easily based on the output of the acceleration sensor 260.

The digital camcorder 270 of this embodiment further includes an image processing section 160 which corrects the tilt of the image by rotating the coordinates of the image by the angle of rotation that has been determined by the controller 180. As a result, an image that has had its tilt corrected appropriately can be output. Consequently, such a corrected image can be stored on a storage medium or presented on the display.

Also, the acceleration sensor 260 detects resultant acceleration by detecting acceleration components in respective directions defined by three orthogonal axes of coordinates, and the controller 180 processes, as the absolute value of the acceleration that has been detected by the acceleration sensor 260, a value that is based on this resultant acceleration. In this manner, the resultant acceleration can be detected accurately.

Furthermore, the angular velocity sensor 250 detects angular velocities around three orthogonal axes of coordinates including an axis of coordinates which is parallel to the optical axis of the image capturing section 270. In this manner, the angular velocities can be detected accurately.

Furthermore, the reference value is set to be the value of acceleration of gravity. In such an embodiment, if the absolute value of the resultant acceleration that has been detected by the acceleration sensor 260 is far different from the value of acceleration of gravity, then the decision can be made that this digital camcorder 100 is in accelerated motion.

### Other Embodiments

Although Embodiment 1 has been described herein as just an example of the technique of the present disclosure, various modifications, replacements, additions or omissions can be readily made on that embodiment as needed and the present disclosure is intended to cover all of those variations. Also, a new embodiment can also be created by combining respective elements that have been described for that embodiment disclosed herein.

Thus, some other embodiments of the present disclosure will be described just as examples.

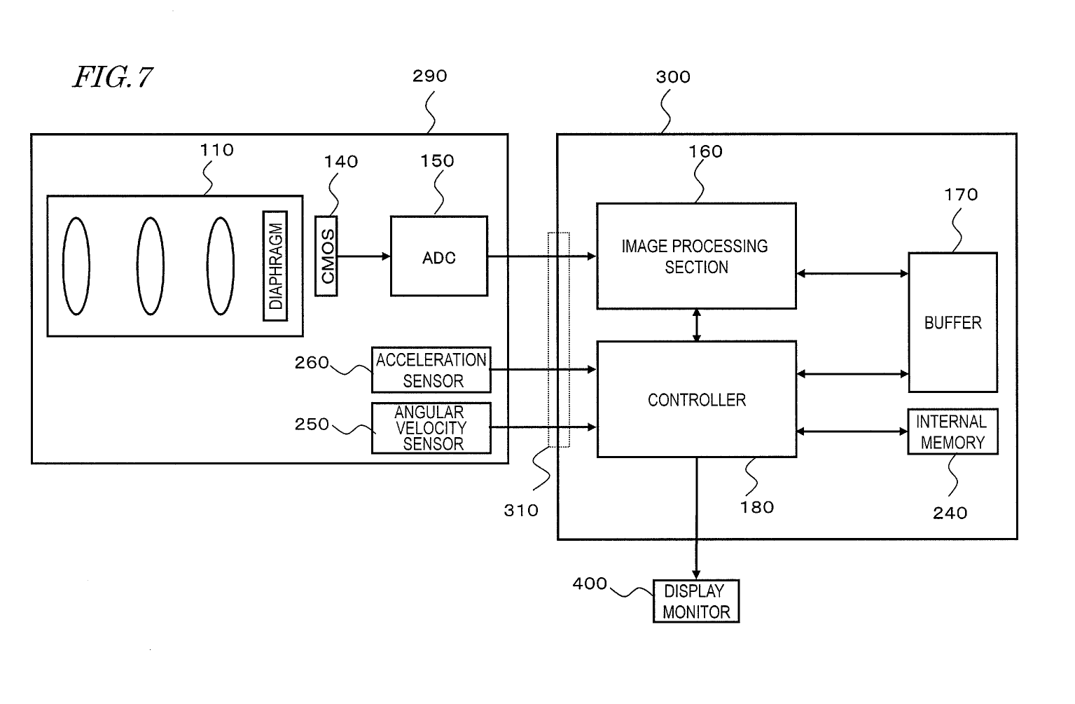

In the embodiment described above, the digital camcorder (which is an example image capture device according to the present disclosure) 100 is configured to perform image tilt correction processing by itself. However, the tilt correction processing may also be carried out by another device (i.e., an image processor) instead of the image capture device itself. FIG. 7 illustrates an exemplary system including such an image processor 300. This system includes an image capture device 290, an image processor 300 and a display monitor 400. The image processor 300 obtains an image that has been generated by the image capture device 290 and corrects the tilt of that image by performing the same processing as what has already been described for the first embodiment.

The image capture device 290 includes an optical system 110, a CMOS sensor 140, an A/D converter 150, an angular velocity sensor 250, and an acceleration sensor 260, each of which may be the same as its counterpart of the first embodiment described above. The image information provided by the A/D converter 150, the acceleration information provided by the acceleration sensor 260, and the angular velocity information provided by the angular velocity sensor 250 are sent to the interface 310 of the image processor 300 either directly or via a storage medium (not shown).

The image processor 300 includes an image processing section 160, a controller 180, a buffer 170, an internal memory 240, and the interface 310. Each of the image processing section 160, controller 180, buffer 170, and internal memory 240 may be the same as its counterpart of the first embodiment described above. The image processor 300 obtains the image information, acceleration information and angular velocity information that have been provided by the image capture device 290 via the interface 310. The image processing section 160 and controller 180 correct the tilt of the image and either displays it on the display monitor 400 or stores it on a storage medium (not shown) by performing the same processing as what has already been described for the first embodiment.

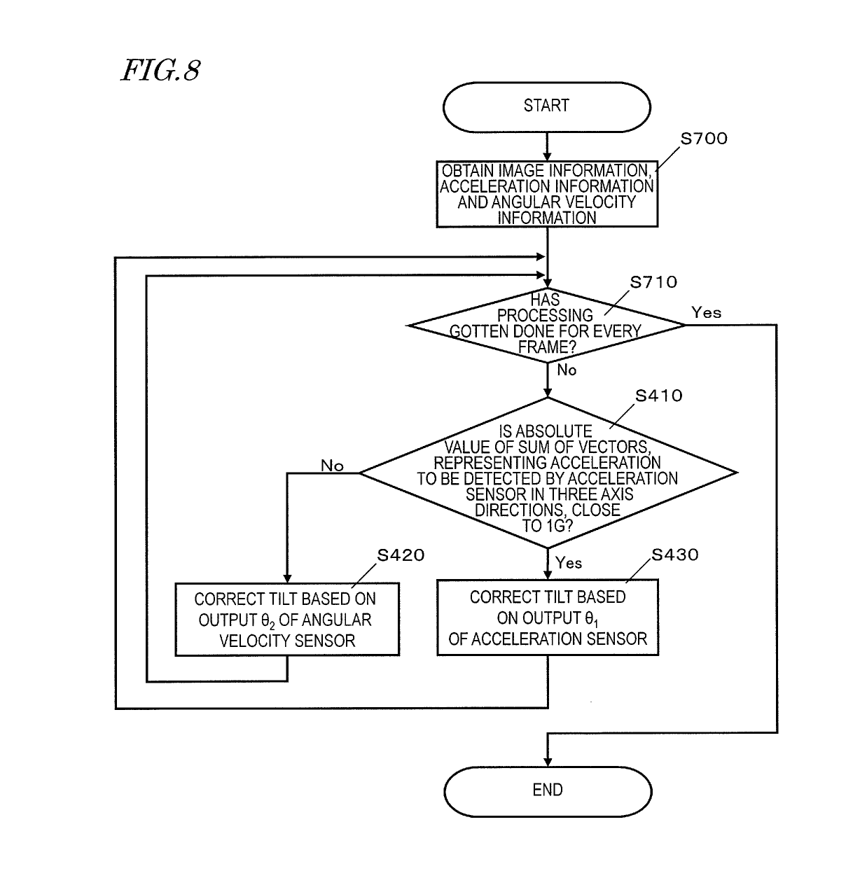

FIG. 8 is a flowchart illustrating an exemplary procedure of processing to be carried out by this image processor. In FIG. 8, any processing step similar to its counterpart shown in FIG. 4 is identified by the same reference numeral. First of all, in Step S700, the interface 310 obtains the image, acceleration information and angular velocity information that have been generated by the image capture device 290. Next, until the decision can be made in Step S710 that the processing has gotten done for every frame of the image obtained, the controller 180 performs the same series of processing steps S410, S420 and S430 over and over again. These processing steps S410 through S430 are the same as their counterparts of the first embodiment described above, and the description thereof will be omitted herein.

By performing these processing steps, the image processor 300 can correct the tilt of the image. As can be seen, the function of correcting the tilt of the image that has been described for the first embodiment does not have to be performed by the image capture device itself. By adopting such a configuration, it is possible to provide a system in which image information, acceleration information and angular velocity information that have been generated by the digital camcorder (image capture device) are transmitted to a remote server computer (image processor) over a network and in which the server computer corrects the tilt of the image and returns the corrected image to the sender. The information may be passed from the image capture device 290 to the image processor 300 either over a network or via a storage medium.

As can be seen, the image processor 300 of this embodiment processes a signal supplied from an image capture device 290. The image capture device 290 includes an image capturing section which generates an image by shooting, an acceleration sensor 260 which detects acceleration, and an angular velocity sensor 250 which detects an angular velocity. The image processor 300 includes: an interface 310 which obtains information about the image, information about the acceleration that has been detected by the acceleration sensor 260, and information about the angular velocity that has been detected by the angular velocity sensor 250; and a controller 180 which determines, if the difference between the absolute value of the acceleration that has been detected by the acceleration sensor 260 and a preset reference value is greater than a predetermined threshold value, the angle of rotation to correct the tilt of the image based on a result of detection obtained by the angular velocity sensor 250. By adopting such a configuration, even an image that has been recorded by the image capture device 290 that is making an accelerated motion can also have its tilt corrected appropriately.

Alternatively, a configuration in which the first half of the processing through the processing step of setting the angle of correction is carried out by the image capture device 290 and in which the processing of correcting the tilt of the image based on the angle of correction is carried out by the image processor 300 may also be adopted. In such a configuration, the controller 180 is provided for the image capture device 290, instead of the image processor 300.

In the embodiments described above, either the digital camcorder 100 or the image capture device 290 is supposed to detect a camera shake information in the roll direction with the angular velocity sensor 250. That is to say, the angular velocity sensor 250 is supposed to function as the “angular velocity detector”. However, this configuration is only an example. Alternatively, the angular velocity sensor 250 may be replaced with an angular acceleration sensor, for example. In that case, by obtaining an angular velocity by finding the integral of the angular acceleration supplied from the angular acceleration sensor with respect to time and then further finding the integral of the angular velocities with respect to time, the tilt can be sensed. Optionally, a camera shake in the roll direction may be detected by analyzing the image, too. Specifically, the angular velocity in the roll direction may be detected by calculating a motion vector in the direction in which the subject included in the captured image rotates. In short, any configuration may be adopted as long as the influence of the camcorder's own rotational shake on the image produced on the image capturing plane of the image sensor can be detected. In those examples, either the controller 180 or the image processing section 160 functions as the “angular velocity detector”.

Furthermore, even though the technique of the present disclosure is supposed to be applied in the embodiments described above to a camcorder that records a moving picture, this technique is also applicable to a digital camera that generates only still pictures.

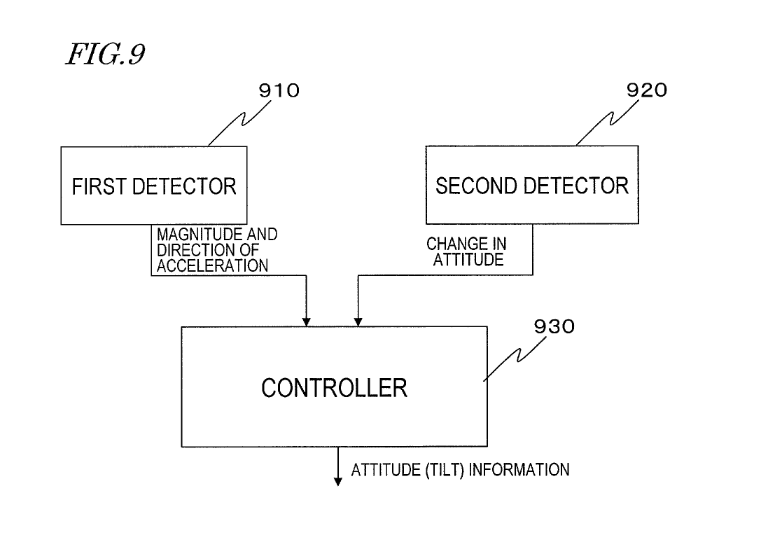

Moreover, the technique of the present disclosure is applicable to not only image capture devices and image processors but also various other kinds of devices (such as mobile telecommunications terminals like tablets and personal digital assistants and game controllers) that need to detect their own attitude. As shown in FIG. 9, such a device may include: a first detector 910 which detects the magnitude and direction of acceleration; a second detector 920 which detects any change in the device's own attitude; and a controller 930 which operates either in a first mode in which the device's own attitude is determined by the direction of the acceleration indicated by a result of detection obtained by the first detector 910 or in a second mode in which the device's own attitude is determined by tracking changes in its own attitude based on a result of detection obtained by the second detector. In that case, in the first or second mode, the controller 930 may determine the device's own attitude with respect to the direction of gravity. Also, in the second mode, in order to track changes in the device's own attitude, the controller 930 may operate so as to calculate the integral of variations in its own attitude. Furthermore, the controller 930 is configured to operate in the first mode if the magnitude of acceleration indicated by a result of detection obtained by the first detector falls within a predetermined range that is defined with respect to the magnitude of the acceleration of gravity, but to operate in the second mode if the magnitude of acceleration indicated by the result of detection obtained by the first detector falls out of the predetermined range. As a result, the controller 930 can determine the device's own attitude (or tilt) and output information about that attitude. It should be noted that the “acceleration” to be detected by the first detector 910 corresponds to the resultant force of the gravity and the inertial force as already described for the first embodiment. That “acceleration” may have direction and magnitude corresponding to those of the acceleration of gravity unless the device itself is making any accelerated motion, but may have different direction and magnitude from those of the acceleration of gravity if the device itself is making an accelerated motion. By adopting such a configuration, unless the device itself is making any accelerated motion, the device's own attitude (tilt) may be determined based on a result of detection obtained by the first detector 910. On the other hand, if the device itself is making an accelerated motion, the device's own attitude may be determined based on a result of detection obtained by the second detector 920.

Furthermore, the technique of the present disclosure is also applicable to a software program defining the tilt correction processing, the image's angle of rotation determining processing, or the attitude detecting processing described above. The operation defined by such a program may be performed as shown in FIG. 4 or 8, for example. Such a program may be either distributed by being stored on removable storage medium or downloaded over telecommunications lines. Various kinds of operations that have been described for the embodiments of the present disclosure can be performed by making a processor built in a computer execute such a program.

Various embodiments have been described as examples of the technique of the present disclosure by providing the accompanying drawings and a detailed description for that purpose.

That is why the elements illustrated on those drawings and/or mentioned in the foregoing description include not only essential elements that need to be used to overcome the problems described above but also other inessential elements that do not have to be used to overcome those problems but are just mentioned or illustrated to give an example of the technique of the present disclosure. Therefore, please do not make a superficial decision that those inessential additional elements are indispensable ones simply because they are illustrated or mentioned on the drawings or the description.

Also, the embodiments disclosed herein are just an example of the technique of the present disclosure, and therefore, can be subjected to various modifications, replacements, additions or omissions as long as those variations fall within the scope of the present disclosure as defined by the appended claims and can be called equivalents.

The technique of the present disclosure is applicable to various kinds of image capture devices including digital camcorders, digital cameras, cellphones with camera, and smart phones with camera. This technique is also applicable to personal computers, server computers, mobile telecommunications terminals, and numerous other kinds of computers as well.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2012-193779 filed Sep. 4, 2012, No. 2013-049314 filed Mar. 12, 2013 and No. 2013-052880 filed Mar. 15, 2013 the entire contents of which are hereby incorporated by reference.

What is claimed is:

1. An image capture device, comprising:
an image capturing section configured to generate an image by shooting;
an acceleration detector configured to detect acceleration;
an angular velocity detector configured to detect angular velocity; and
a controller configured to determine, when the difference between the absolute value of the acceleration that has been detected by the acceleration detector and a preset reference value is greater than a predetermined threshold value, an angle of rotation of the image based on a result of detection obtained by the angular velocity detector.

2. The image capture device of claim 1, wherein the controller is configured to determine, when the difference is smaller than the threshold value, the angle of rotation of the image based on a result of detection obtained by the acceleration detector.

3. The image capture device of claim 1, further comprising an image processing section configured to correct the tilt of the image by rotating the coordinates of the image by the angle of rotation that has been determined by the controller.

4. The image capture device of claim 1, wherein the acceleration detector detects resultant acceleration by detecting acceleration components in respective directions defined by three orthogonal axes of coordinates, and
wherein the controller processes, as the absolute value of the acceleration, a value that is based on the resultant acceleration that has been detected by the acceleration detector.

5. The image capture device of claim 1, wherein the angular velocity detector is an angular velocity sensor.

6. The image capture device of claim 5, wherein the angular velocity sensor detects angular velocities around three orthogonal axes of coordinates including an axis of coordinates that is parallel to the optical axis of the image capturing section.

7. The image capture device of claim 1, wherein the reference value is set to be the value of the acceleration of gravity.

8. The image capture device of claim 1, wherein if the value of the acceleration of gravity is represented as 1 G, the threshold value is set to be smaller than 0.01 G.

9. An image processing method, for processing a signal supplied from an image capture device including an image capturing section configured to generate an image by shooting, an acceleration detector configured to detect acceleration, and an angular velocity detector configured to detect angular velocity, the method comprising:
obtaining information about the image, information about the acceleration that has been detected by the acceleration detector, and information about the angular velocity that has been detected by the angular velocity detector; and
determining, when the difference between the absolute value of the acceleration that has been detected by the acceleration detector and a preset reference value is greater than a predetermined threshold value, an angle of rotation of the image based on a result of detection obtained by the angular velocity detector.

10. A device, comprising:
a first detector configured to detect a magnitude and a direction of acceleration;
a second detector configured to detect a change in the device's own attitude; and
a controller configured to operate either in a first mode in which the device's own attitude is determined by the direction of the acceleration indicated by a result of detection obtained by the first detector or in a second mode in which the device's own attitude is determined by tracking changes in its own attitude based on a result of detection obtained by the second detector,
wherein when the magnitude of acceleration indicated by a result of detection obtained by the first detector falls within a predetermined range that is defined with respect to the magnitude of the acceleration of gravity, the controller operates in the first mode, and
when the magnitude of acceleration indicated by the result of detection obtained by the first detector falls out of the predetermined range, the controller operates in the second mode.

11. The device of claim 10, wherein the controller determines the device's own attitude by calculating, in the second mode, the integral of variations in the device's own attitude based on a result of detection obtained by the second detector.
